(19) United States
(12) Patent Application Publication
(10) Pub. No.: US 2014/0034206 A1
(43) Pub. Date: Feb. 6, 2014

(54) RUBBER COMPOSITION FOR A SIDEWALL REINFORCING LAYER OF A RUN-FLAT TIRE AND THE RUN-FLAT TIRE

(71) Applicant: SUMITOMO RUBBER INDUSTRIES, LTD., Kobe-shi (JP)

(72) Inventor: Yoichi MIZUNO, Kobe-shi (JP)

(73) Assignee: SUMITOMO RUBBER INDUSTRIES, LTD., Kobe-shi (JP)

(21) Appl. No.: 13/856,186

(22) Filed: Apr. 3, 2013

(30) Foreign Application Priority Data
Aug. 1, 2012 (JP) 2012-171046

(51) Int. Cl. C08L 9/00; C08L 7/00

(52) U.S. Cl. CPC C08L 9/00; B60C 1/0025; C08L 7/00
USPC 152/516; 524/508

(57) ABSTRACT

It is an object of this invention to provide a rubber composition for a sidewall reinforcing layer of a run-flat tire having superior elastic modulus, low heat build-up property and elongation at break with a good balance and being capable of improving run-flat performance, and the run-flat tire. The present invention provides a rubber composition for a sidewall reinforcing layer of a run-flat tire containing predetermined amounts of carbon black having a iodine absorption number of 50 mg/g or less, silica having a BET specific surface area of 170 m²/g or less, phenol resin and/or modified phenol resin and methylene group-donating compound based on 100 parts by mass of diene rubber component, and the run-flat tire.

### TECHNICAL FIELD

This invention is related to a rubber composition for a sidewall reinforcing layer of a run-flat tire, and to the run-flat tire having the sidewall reinforcing layer using this rubber composition.

### BACKGROUND ART

Currently, a run-flat tire having a high hardness sidewall reinforcing layer arranged between its sidewall and carcass has been in practical use, allowing a vehicle to run a certain distance even if air pressure is lost due to a puncture or the like. Therefore, there is no need any more to always have a spare tire ready and it can be expected to reduce the weight of a whole vehicle. However, with a punctured run-flat tire (with an under-inflated tire), running in a run-flat condition is limited in terms of speed, distance and the like, and there is a demand for further improvement in run-flat performance.

Methods for improving run-flat performance include;

(1) preventing a rupture due to deformity by increasing the thickness of a sidewall reinforcing layer to reduce deformity,
(2) increasing the amount of reinforcement filler such as carbon black to be contained in the rubber composition for the sidewall reinforcing layer in order that increased hardness and elastic modulus of the sidewall reinforcing layer reduce deformity, and
(3) without increasing the amount of carbon black or the like, increasing the vulcanizing density by using large amounts of vulcanizing agent or vulcanization accelerator so as to reduce deformity and heat build-up (see JP 2008-214458 A).

However, in the case of above (1), the increase in the weight of a tire contradicts the initial purpose of a run-flat tire, i.e. weight saving. Moreover, in the case of above (2), the workload on steps including kneading and extrusion becomes heavier, and the improvement in run-flat performance cannot be expected very much because of higher heat build-up property after vulcanization. Furthermore, in the case of above (3), there is a problem of decrease in breaking strength due to smaller stretch of a rubber.

Moreover, as an effective way of improving run-flat performance, a method of improving the low heat build-up property of a sidewall reinforcing layer is known, but it is important to improve low heat build-up property while reducing deformity by maintaining a high hardness (elastic modulus) at a high temperature of the rubber composition for a sidewall reinforcing layer in order to improve run-flat performance. Furthermore, decline in elongation at break at a high temperature allows a rupture to easily develop after aging. Namely, it is important to assure three physical properties, i.e. elastic modulus, low heat build-up property and elongation at break of the rubber composition for a sidewall reinforcing layer in order to improve run-flat performance.

### DISCLOSURE OF INVENTION

The purpose of this invention is to provide a rubber composition for a sidewall reinforcing layer of a run-flat tire having superior elastic modulus, low heat build-up property and elongation at break with a good balance and being capable of improving run-flat performance, and a run-flat tire having a sidewall reinforcing layer using this rubber composition.

This invention is related to a rubber composition for a sidewall reinforcing layer of a run-flat tire containing 10 to 30 parts by mass of carbon black having an iodine absorption number of 50 mg/g or less, 20 to 60 parts by mass of silica having a BET specific surface area of 170 m²/g or less, 0.5 to 2.8 parts by mass of phenol resin and/or modified phenol resin and 0.05 to 0.5 part by mass of methylene group-donating compound, based on 100 parts by mass of diene rubber component.

Furthermore, it is preferred to contain resorcin series resin.

It is preferred that total content of phenol resin and/or modified phenol resin and resorcin series resin is 2.0 to 5.0 parts by mass based on 100 parts by mass of diene rubber component.

Moreover, this invention is related to a run-flat tire having a sidewall reinforcing layer using said rubber composition for a sidewall reinforcing layer.

According to this invention, it is possible to provide a rubber composition for a sidewall reinforcing layer of a run-flat tire having superior elastic modulus, low heat build-up property and elongation at break with a good balance and being capable of improving run-flat performance, and a run-flat tire having a sidewall reinforcing layer using this rubber composition, by compounding predetermined amounts of predetermined silica, carbon black, phenol resin and/or modified phenol resin and methylene group-donating compound, based on diene rubber component.

The rubber composition for a sidewall reinforcing layer of a run-flat tire of this invention contains predetermined amounts of predetermined carbon black, silica, phenol resin and/or modified phenol resin and methylene group-donating compound based on diene rubber component.

The diene rubber component includes natural rubber (NR), isoprene rubber (IR), butadiene rubber (BR), styrene-butadiene rubber (SBR), chloroprene rubber (CR), styrene isoprene butadiene rubber (SIBR), styrene isoprene rubber (SIR), isoprene-butadiene rubber, epoxynized natural rubber (ENR) and the like. These diene rubber components can be used alone or in combination of two or more. It is preferred to contain NR, IR, BR and/or SBR among them, because of the good balance between their low heat build-up property and flex resistance.

The above NR includes deproteinized natural rubber (DPNR) and highly purified natural rubber (HPNR) as well. For this NR, general NRs in tire industry such as SIR20, RSS#3, TSR20, for example, can be used.

The content of NR as the diene rubber component, if any, is preferably 30% by mass or more, more preferably 35% by mass or more, and further preferably 40% by mass or more, because of the superiority in its low heat build-up property. In addition, because too much content of NR tends to result in inferior flex resistance, 60% by mass or less is preferred and 50% by mass or less is more preferred.

Various BRs such as high-cis-1,4-polybutadiene rubber (high-cis BR), butadiene rubber containing 1,2-syndiotactic polybutadiene crystal (SPB-containing BR) and tin-modified butadiene rubber (tin-modified BR) can be used as BR.

The high-cis BR is butadiene rubber where the content rate of cis-1,4 bond is 90% by mass or more. Examples of such high-cis BR include BR1220 manufactured by ZEON Corporation, BR130B and BR150B by Ube Industries, Ltd. and the like.

The SPB-containing BR is not just the BR having 1,2-syndiotactic polybutadiene crystals dispersed therein, but includes BR having them chemically bonded therewith before dispersion. Such SPB-containing BR includes VCR-303, VCR-412 and VCR-617 manufactured by Ube Industries, Ltd. and the like.

The tin-modified BR is obtained by polymerizing 1,3-butadiene with a lithium initiator and adding a tin compound thereto, and further includes such tin-modified BRs also having the terminal ends of modified BR molecules bonded by a tin-carbon bond. Examples of such tin-modified BR include BR1250H manufactured by ZEON Corporation and the like.

Among those various BRs, it is preferred to use the high-cis BR because of the superior balance between its low heat build-up property and flex resistance.

The content of BR as diene rubber component, if any, is preferably 40% by mass or more, more preferably 50% by mass or more, and further preferably 60% by mass or more, because of the superiority in its flex resistance. Moreover, because too much content of BR tends to result in inferiority in low heat build-up property, 70% by mass or less is preferred and 65% by mass or less is more preferred.

Various SBRs such as emulsion polymerized SBR (E-SBR) obtained by emulsion polymerization, solution polymerized SBR (S-SBR) obtained by solution polymerization, modified E-SBR and modified S-SBR obtained by modifying those SBRs by 3-Aminopropyldimethylmethoxysilane, etc. and the like can be used as SBR.

The content of SBR as the diene rubber component, if any, is preferably 10% by mass or more, and more preferably 20% by mass or more, because of the superiority in the balance between its rigidity and low heat build-up property. Moreover, because too much content of SBR tends to result in inferiority in low heat build-up property, 30% by mass or less is preferred and 25% by mass or less is more preferred.

The rubber composition for a sidewall reinforcing layer of this invention contains predetermined carbon black to improve rubber strength.

Iodine absorption number (IA) of the carbon black is 50 mg/g or less and preferably 45 mg/g or less. If IA of carbon black exceeds 50 mg/g, there is a tendency of deterioration of low heat build-up property. Moreover, IA of carbon black is preferably 30 mg/g or more, more preferably 35 mg/g or more, and further preferably 40 mg/g or more. If IA of carbon black is less than 30 mg/g, there is a tendency of deterioration of reinforcing property. By the way, iodine absorption number of carbon black is a value measured pursuant to ASTM D1765-05.

The content of the carbon black is 10 parts by mass or more based on 100 parts by mass of diene rubber component, and preferably 20 parts by mass or more. If the content of carbon black is less than 10 parts by mass, there is a tendency of deterioration of reinforcing property. Moreover, the content of carbon black is 30 parts by mass or less. If the content of carbon black exceeds 30 parts by mass, there is a tendency of deterioration of low heat build-up property.

The rubber composition for a sidewall reinforcing layer of this invention contains predetermined silica in order to assure both elastic modulus and low heat build-up property.

BET specific surface area (BET) of the silica is 170 m²/g or less and preferably 130 m²/g or less. If BET of silica exceeds 170 m²/g, there is a tendency of deterioration of low heat build-up property. Moreover, BET of silica is preferably 100 m²/g or more, and more preferably 110 m²/g or more. If BET of silica is less than 100 m²/g, there is a tendency of deterioration of reinforcing property. BET specific surface area of silica is a value measured by BET method pursuant to ASTM D3037-81.

The content of the silica is 20 parts by mass or more based on 100 parts by mass of diene rubber component, and preferably 40 parts by mass or more. If the content of silica is less than 20 parts by mass, there is a tendency of deterioration of reinforcing property. Moreover, the content of silica is 60 parts by mass or less. If the content of silica exceeds 60 parts by mass, there is a tendency of deterioration of low heat build-up property.

It is preferred that the rubber composition for a sidewall reinforcing layer of this invention contains silane coupling agent along with silica. For the silane coupling agent, any silane coupling agents conventionally used in combination with silica in rubber industry can be used, examples of which include sulfide series such as bis(3-triethoxysilylpropyl)tetrasulfide and bis(3-triethoxysilylpropyl)disulfide, mercapto series such as 3-mercaptopropyltrimethoxysilane, vinyl series such as vinyl triethoxysilane, amino series such as 3-aminopropyltriethoxysilane, glycidoxy series such as γ-glycidoxypropyltriethoxysilane, nitro series such as 3-nitropropyltrimethoxysilane, chloro series such as 3-chloropropyltrimethoxysilan and the like. These can be used alone or in combination of two or more. Among them, sulfide series and mercapto series are preferred because of their strong bonding force to silica and superiority in heat build-up property.

The content of silane coupling agent, if any, is preferably 6 parts by mass or more based on 100 parts by mass of silica, and more preferably 8 parts by mass or more. If the content of silane coupling agent is less than 6 parts by mass, there is a tendency of silica having insufficient dispersibility. Moreover, the content of silane coupling agent is preferably 10 parts by mass or less, and more preferably 8 parts by mass or less. If it exceeds 10 parts by mass, there is a tendency of its effect failing to match the increased cost.

The rubber composition for a sidewall reinforcing layer of this invention can improve low heat build-up property and rigidity by containing phenol resin and/or modified phenol resin.

The phenol resin includes the resultant of phenol reacted with aldehydes such as formaldehyde, acetaldehyde and furfral in the presence of an acid or alkali catalyst. Among them, novolac-type phenolic resin and the like obtained by reaction with acid catalyst is preferred. Moreover, the modified phenol resin includes resins obtained by modifying phenol resin using cashew oil, toll oil, linseed oil, various animal and plant oils, unsaturated aliphatic acid, rosin, alkylbenzene resin, aniline and melamine and the like. In this regard, the “phenol resin” of this invention does not include resin made by polymerizing not phenol, but cresol, resorcin, etc.

The content of phenol resin and/or modified phenol resin is 0.5 part by mass or more based on 100 parts by mass of diene rubber component, preferably 1.0 part by mass or more, and more preferably 2.0 parts by mass or more. If the content of phenol resin and/or modified phenol resin is less than 0.5 part by mass, there is a tendency of failing to provide sufficient rigidity. Moreover, the content of phenol resin and/or modified phenol resin is 2.8 parts by mass or less, and more preferably 2.5 parts by mass or less. If the content of phenol resin and/or modified phenol resin exceeds 2.8 parts by mass, there is a tendency of worsening of the balance between rigidity improvement effect and low heat build-up property.

The rubber composition for a sidewall reinforcing layer of this invention can improve elastic modulus, low heat build-up property and elongation at break with a good balance by containing said phenol resin and/or modified phenol resin as well as methylene group-donating compound.

The methylene group-donating compound includes partial condensate of hexamethoxymethylolmelamine (HMMM), partial condensate of hexamethylolmelaminepentamethyl ether (HMMPME) and the like. Among them, partial condensate of HMMM is preferred because of its superiority in reactivity.

The content of methylene group-donating compound is 0.05 part by mass or more based on 100 parts by mass of diene rubber component, more preferably 0.10 part by mass or more, and further preferably 0.20 part by mass or more. If the content of methylene group-donating compound is less than 0.05 part by mass, there is a tendency of insufficient improvement effect of rigidity. Moreover, the content of methylene group-donating compound is 0.5 part by mass or less, and preferably 0.4 part by mass or less. If the content of methylene group-donating compound exceeds 0.5 part by mass, there is a tendency of worsening of the balance between rigidity and low heat build-up property.

The resorcin series resin includes resorcin resin and modified resorcin resin. Resorcin resin includes condensate of resorcin and formaldehyde. Moreover, modified resorcin resin includes, for example, resorcin resin having partially alkylated repeating units.

The content of said resorcin series resin, if any, is preferably 0.5 part by mass or more based on 100 parts by mass of diene rubber component, more preferably 1.0 part by mass or more, and further preferably 2.0 parts by mass or more. If the content of resorcin series resin is less than 0.5 part by mass, there is a tendency of insufficient improvement effect of rigidity. Moreover, the content of resorcin series resin is preferably 3 parts by mass or less. If the content of resorcin series resin exceeds 3 parts by mass, there is a tendency of worsening of the balance between rigidity improvement effect and low heat build-up property.

Moreover, the total content of phenol resin and/or modified phenol resin and resorcin series resin, if resorcin series resin is to be contained, is preferably 2.0 parts by mass or more based on 100 parts by mass of diene rubber component, and more preferably 2.5 parts by mass or more. If the total content is less than 2.0 parts by mass, there is a tendency of insufficient improvement effect of rigidity. Moreover, the total content of these is preferably 5 parts by mass or less, and more preferably 3 parts by mass or less. If the total content exceeds 5 parts by mass, there is a tendency of worsening of the balance between rigidity improvement effect and low heat build-up property.

In addition to the above materials, the rubber composition for a sidewall reinforcing layer of this invention can be appropriately compounded of reinforcement filler other than said carbon black and silica generally used in tire industry, various oils, flexibilizer, wax, zinc oxide, stearic acid, antioxidant, sulfur, various vulcanization accelerators and the like, if necessary.

A method for manufacturing the rubber composition for a sidewall reinforcing layer of this invention is not especially limited and known methods can be used. For example, it can be manufactured by a method of kneading each of said components using a rubber kneader such as an open roll, a Banbury mixer and an internal mixer before vulcanization.

The rubber composition for a sidewall reinforcing layer of this invention is a rubber composition having superior elastic modulus, low heat build-up property and elongation at break with a good balance and can provide a run-flat tire with excellent run-flat performance when used as a sidewall reinforcing layer of a run-flat tire.

Moreover, the run-flat tire of this invention can be manufactured by a usual method using the rubber composition for a sidewall reinforcing layer of this invention. Namely, unvulcanized rubber composition compounded of said compounding agents and additive agents as needed is extruded into the shape of the sidewall reinforcing layer and bonded to other tire members on a tire molding machine so that an unvulcanized tire is formed by molding in a usual manner. The run-flat tire of this invention can be manufactured by heating and pressurizing this unvulcanized tire in a vulcanizer.

### EXAMPLES

This invention will be described specifically based on Examples, only to which this invention is not limited.

Various chemicals used in the Examples and Comparative Examples are collectively shown as follows.

### NR: RSS#3

BR: BR150B (cis content: 98% by mass) manufactured by Ube Industries, Ltd.
SBR: SBR1502 manufactured by Sumitomo Chemical Co., Ltd.
Carbon black A: Diablack FEF (iodine absorption number: 43 mg/g) manufactured by Mitsubishi Chemical Corporation
Carbon black B: Showblack N351 (iodine absorption number: 68 mg/g) manufacture by Cabot Japan K. K.
Silica A: Z1115MP (BET: 115 m²/g) manufactured by Rhodia S.A.
Silica B: Ultrasil 7000GR (BET: 175 m²/g) manufactured by Evonik Degussa GmbH
Silane coupling agent: Si266 manufactured by Evonik Degussa GmbH
Phenol resin A: PR12686 (cashew oil modified phenol resin) manufactured by Sumitomo Bakelite Co., Ltd.
Phenol resin B: SP6700 (cashew oil modified phenol resin) manufactured by Nippon Shokubai Co., Ltd.
HMMM: partial condensate of Sumikanol 508 (Hexamethoxymethylolmelamine (HMMM)) manufactured by Taoka Chemical Co., Ltd (resin content: 100% by mass)
Resorcin resin: RSM manufactured by Sumitomo Chemical Co., Ltd. (resin content: 60% by mass)
Stearic acid: stearic acid “Tsubaki” manufactured by NOF Corporation
Zinc oxide: Two kinds of zinc oxides manufactured by Mitsui Mining 86 Smelting Co., Ltd.
Antioxidant: Antigen 6C(N-(1,3-dimethylbutyl)-N′-phenyl-p-phenylenediamine) manufactured by Sumitomo Chemical Co., Ltd.

Sulfur: powder sulfur manufactured by Karuizawa Sulfur Co., Ltd.

Vulcanization accelerator: Nocceler NS (N-tert-butyl-2-benzothiazolylsulfenamide) manufactured by Ouchi Shinko Chemical Industrial Co., Ltd.

### Examples 1 to 13 and Comparative Examples 1 to 7

In accordance with the formulation shown in Table 1 and Table 2, chemicals excluding sulfur and vulcanization accelerator were kneaded for four minutes under the condition of temperature of 150° C. using a 1.7 litter internal Banbury mixer in order to obtain a kneaded product. Next, sulfur and vulcanization accelerator were added to the obtained kneaded product which was then kneaded for three minutes under the condition of temperature of 80° C. using an open roll so as to obtain an unvulcanized rubber composition. Furthermore, the obtained unvulcanized rubber composition underwent press vulcanization for 20 minutes under the condition of temperature of 160° C. so as to obtain a rubber composition for each test.

Moreover, said unvulcanized rubber composition was extruded and molded into the shape of the sidewall reinforcing layer and bonded to other tire members in order to form an unvulcanized tire which underwent press vulcanization for 12 minutes under the condition of temperature of 160° C. so that a run-flat tire (size: 215/45ZR17) for each test was manufactured.

### <Viscoelastic Property Test>

The test rubber composition was cut into pieces of width 4 mm, length 40 mm and thickness 2 mm in order to measure complex elastic modulus (E*) and viscoelastic physical property of loss tangent (tan δ) using a viscoelasticity measuring apparatus manufactured by Iwamoto Seisakusyo K.K. Dynamic strain of 1%, vibrational frequency of 10 Hz and temperature of 100° C. were given as measuring conditions. Larger value of E* indicates superiority in elastic modulus and less deformity, and performance target is 9 MPa or more, and more preferably 12 MPa or more. Moreover, smaller value of tan δ indicates superiority in low heat build-up property, and performance target is 0.14 or less, and more preferably 0.13 or less.

### <Tensile Test>

A No. 3 dumbbell type test piece comprising the test rubber composition was used to carry out a tensile test under the condition of temperature 100° C. in accordance with JIS K 6251 “Vulcanized rubber and thermoplastic rubber—Determination method of tensile property” so as to measure elongation at break EB (%). Larger EB indicates superiority in elongation at break, and performance target is 250% or more.

### <Run Flat Endurance Index>

The test run-flat tire was mounted on a rim to run it with an inner pressure of air of 0 kPa on a drum at the speed of 80 km/h, the running distance until the tire was ruptured was expressed in index notation. A larger index indicates superiority in run-flat endurance.

(Run flat endurance index)=(Running distance for each case)/(Running distance of the Comparative Example 1)×100

TABLE 1

| Comparative | | | | | | | | | | | | | |
|---|---|---|---|---|---|---|---|---|---|---|---|---|---|
| Examples | | Examples | | | | | | | | Comparative Examples | | | |
| 1 | 2 | 1 | 2 | 3 | 4 | 5 | 6 | 7 | 8 | 3 | 4 | 5 | 6 |

Content (part by mass)

| | | | | | | | | | | | | | | |
|---|---|---|---|---|---|---|---|---|---|---|---|---|---|---|
| NR | 40 | 40 | 40 | 40 | 40 | 40 | 40 | 40 | 40 | 40 | 40 | 40 | 40 | 40 |
| BR | 60 | 60 | 60 | 60 | 60 | 60 | 60 | 60 | 40 | 60 | 60 | 60 | 60 | 60 |
| SBR | — | — | — | — | — | — | — | — | 20 | — | — | — | — | — |
| Carbon black A | 20 | 20 | 20 | 20 | 20 | 20 | 20 | 20 | 20 | 30 | 20 | 20 | 20 | — |
| Carbon black B | — | — | — | — | — | — | — | — | — | — | — | — | — | 20 |
| Silica A | 40 | 40 | 40 | 40 | 40 | 40 | 40 | 40 | 40 | 30 | 40 | 40 | — | 40 |
| Silica B | — | — | — | — | — | — | — | — | — | — | — | — | 40 | — |
| Silane | 3.2 | 3.2 | 3.2 | 3.2 | 3.2 | 3.2 | 3.2 | 3.2 | 3.2 | 2.4 | 3.2 | 3.2 | 3.2 | 3.2 |
| coupling | | | | | | | | | | | | | | |
| agent | | | | | | | | | | | | | | |
| Phenol resin A | — | 0.25 | 0.5 | 1.0 | 2.0 | 2.5 | 2.8 | — | 2.5 | 2.5 | 3.0 | — | — | — |
| Phenol resin B | — | — | — | — | — | — | — | 2.0 | — | — | — | — | — | — |
| Resorcin resin | — | — | — | — | — | — | — | — | — | — | — | 4.2 | — | — |
| (resin contents) | | | | | | | | | | | | (2.5) | | |
| HMMM | — | 0.025 | 0.05 | 0.10 | 0.20 | 0.50 | 0.50 | 0.20 | 0.50 | 0.50 | 0.30 | 0.50 | 0.50 | 0.50 |
| Stearic acid | 2 | 2 | 2 | 2 | 2 | 2 | 2 | 2 | 2 | 2 | 2 | 2 | 2 | 2 |
| Zinc oxide | 5 | 5 | 5 | 5 | 5 | 5 | 5 | 5 | 5 | 5 | 5 | 5 | 5 | 5 |
| Antioxidant | 2 | 2 | 2 | 2 | 2 | 2 | 2 | 2 | 2 | 2 | 2 | 2 | 2 | 2 |
| Sulfur | 4.5 | 4.5 | 4.5 | 4.5 | 4.5 | 4.5 | 4.5 | 4.5 | 4.5 | 4.5 | 4.5 | 4.5 | 4.5 | 4.5 |
| Vulcanization | 3 | 3 | 3 | 3 | 3 | 3 | 3 | 3 | 3 | 3 | 3 | 3 | 3 | 3 |
| accelerator | | | | | | | | | | | | | | |

Evaluation results

| | | | | | | | | | | | | | | |
|---|---|---|---|---|---|---|---|---|---|---|---|---|---|---|
| Tanδ (100° C.) | 0.060 | 0.070 | 0.081 | 0.087 | 0.095 | 0.119 | 0.128 | 0.099 | 0.130 | 0.134 | 0.142 | 0.115 | 0.145 | 0.140 |
| E* (100° C.) | 7.0 | 7.5 | 9.2 | 10.1 | 11.4 | 13.3 | 14.2 | 11.8 | 14.2 | 14.4 | 14.9 | 8.6 | 15.3 | 16.5 |
| EB (%) | 320 | 315 | 305 | 295 | 275 | 260 | 255 | 265 | 260 | 310 | 240 | 300 | 275 | 270 |
| (100° C.) | | | | | | | | | | | | | | |
| Run-flat | 100 | 109 | 119 | 121 | 125 | 127 | 129 | 128 | 125 | 128 | 120 | 109 | 111 | 114 |
| performance | | | | | | | | | | | | | | |

TABLE 2

| | | | | | Com. |
|---|---|---|---|---|---|
| Ex. | | | | | Ex. |
| 9 | 10 | 11 | 12 | 13 | 7 |

Content (part by mass)

| | | | | | | |
|---|---|---|---|---|---|---|
| NR | 40 | 40 | 40 | 40 | 40 | 40 |
| BR | 60 | 60 | 60 | 60 | 60 | 60 |
| SBR | — | — | — | — | — | — |
| Carbon black A | 20 | 20 | 20 | 20 | 20 | 20 |
| Carbon black B | — | — | — | — | — | — |
| Silica A | 40 | 40 | 40 | 40 | 40 | 40 |
| Silica B | — | — | — | — | — | — |
| Silane coupling | 3.2 | 3.2 | 3.2 | 3.2 | 3.2 | 3.2 |
| agent | | | | | | |
| Phenol resin A | 0.5 | 1.0 | 2.0 | 2.5 | 2.5 | 2.8 |
| Phenol resin B | — | — | — | — | — | — |
| Resorcin resin | 4.2 | 1.7 | 2.1 | 2.1 | 4.2 | 4.2 |
| (resin content) | (2.5) | (1.0) | (1.25) | (1.25) | (2.5) | (2.5) |
| HMMM | 0.50 | 0.30 | 0.40 | 0.40 | 0.50 | 0.70 |
| Stearic acid | 2 | 2 | 2 | 2 | 2 | 2 |
| Zinc oxide | 5 | 5 | 5 | 5 | 5 | 5 |
| Antioxidant | 2 | 2 | 2 | 2 | 2 | 2 |
| Sulfur | 4.5 | 4.5 | 4.5 | 4.5 | 4.5 | 4.5 |
| Vulcanization | 3 | 3 | 3 | 3 | 3 | 3 |
| accelerator | | | | | | |

Evaluation results

| | | | | | | |
|---|---|---|---|---|---|---|
| Tanδ (100° C.) | 0.119 | 0.098 | 0.110 | 0.120 | 0.135 | 0.145 |
| E* (100° C.) | 12.0 | 12.4 | 14.0 | 14.2 | 16.0 | 15.7 |
| EB (%) | 280 | 310 | 280 | 275 | 250 | 245 |
| (100° C.) | | | | | | |
| Run-flat | 127 | 132 | 136 | 138 | 139 | 134 |
| performance | | | | | | |

It can be seen from the results in Table 1 and Table 2 that the rubber composition for a sidewall reinforcing layer containing, based on diene rubber component, predetermined amounts of predetermined silica, carbon black, phenol resin and/or modified phenol resin and methylene group-donating compound is superior in elastic modulus, low heat build-up property and elongation at break with a goods balance. Furthermore, it can be seen as well that the run-flat tires having sidewall reinforcing layers using these rubber compositions are superior in run-flat endurance.

What is claimed is:

1. A rubber composition for a sidewall reinforcing layer of a run-flat tire containing;
10 to 30 parts by mass of carbon black having a iodine absorption number of 50 mg/g or less,
20 to 60 parts by mass of silica having a BET specific surface area of 170 m²/g or less,
0.5 to 2.8 parts by mass of phenol resin and/or modified phenol resin, and
0.05 to 0.5 parts by mass of methylene group-donating compound, based on 100 parts by mass of diene rubber component.

2. The rubber composition for the sidewall reinforcing layer of the run-flat tire according to claim 1 further containing resorcin series resin.

3. The rubber composition for the sidewall reinforcing layer of the run-flat tire according to claim 2, wherein the total content of phenol resin and/or modified phenol resin and resorcin series resin is 2.0 to 5.0 parts by mass based on 100 parts by mass of diene rubber component.

4. A run-flat tire having a sidewall reinforcing layer using the rubber composition for the sidewall reinforcing layer of the run-flat tire according to any one of claim 1.

5. A run-flat tire having a sidewall reinforcing layer using the rubber composition for the sidewall reinforcing layer of the run-flat tire according to any one of claim 2.

6. A run-flat tire having a sidewall reinforcing layer using the rubber composition for the sidewall reinforcing layer of the run-flat tire according to any one of claim 3.
